(19) United States
(12) Patent Application Publication
(10) Pub. No.: US 2012/0102814 A1
(43) Pub. Date: May 3, 2012

(54) BUOYANT FISHING LURE ENCLOSURE

(76) Inventor: Michael Christensen, Hermitage, TN (US)

(21) Appl. No.: 12/915,007

(22) Filed: Oct. 29, 2010

(51) Int. Cl. A01K 97/06

(52) U.S. Cl. 43/25.2

(57) ABSTRACT

An enclosure for a fishing lure includes first and second panels pivotally attached at a pivoting joint. The panels define an interior cavity shaped for housing a fishing lure. The enclosure can be positioned radially onto a fishing rod for protectively covering a fishing lure while the lure is temporarily stored on the rod. The enclosure includes first and second flanges that extend outwardly from the enclosure. The enclosure can be manually opened and closed by squeezing the flanges toward each other. A spring can be disposed between the first and second panels along the pivoting joint for biasing the enclosure in a closed position. The spring in some embodiments includes a torsion spring with a first end extending into the first flange and a second end extending into the second flange. The first and second panels can include a buoyant material for providing floatation to the enclosure apparatus. A liner can also be positioned inside the interior cavity for preventing a hook from puncturing the first and second panels.

### BACKGROUND OF THE INVENTION TECHNICAL FIELD

The present invention relates to fishing equipment. More particularly, the present invention relates to devices for protectively covering a fishing lure on a fishing rod during transport or storage.

### BACKGROUND ART

Conventional fishing rods typically provide an elongated rod structure having a plurality of eyelets, or ferrules, disposed on the rod at intermediate positions along the length of the rod. Fishing line generally extends from a reel attached to the handle of the fishing rod through the eyelets, and a lure having one or more hooks is tied onto the end of the fishing line. During use, it is common for users of fishing rods to temporarily hook the fishing lure through one of the eyelets to secure the lure during storage or transport. Such storage generally prevents the user from having to remove the lure completely from the line after fishing, but rather allows the user to keep the lure tied to the line for convenience.

One problem associated with temporarily stowing a hooked lure on an eyelet of a fishing rod is the tendency of that hook or additional hooks to become entangled with the surrounding environment. When a lure is temporarily stowed in such a manner, hooks are generally exposed to the environment, thereby allowing entanglement with persons or objects. Additionally, the hook can contact the fishing line and cause a weakness. A common situation where such undesirable entanglement occurs is when a rod with a stowed lure is transported in an automobile or boat. Such entanglement can cause damage to the vehicle interior or other materials in the surrounding environment and can cause injury to individuals or pets nearby.

Another problem associated with temporarily stowing a hooked lure on an eyelet of a fishing rod is potential damage to the lure. While stowed, the lure is exposed to the environment and can be damaged by contact with surrounding objects. Such damage is especially undesirable when the lure includes a painted or delicate exterior surface.

Others have attempted to overcome the problems associated with temporarily stowing a hooked lure on an eyelet of a fishing rod by providing enclosure structures for surrounding the lure while stowed on the rod. Such conventional enclosure structures, however, are typically formed of materials that do not provide floatation to the enclosure. Additionally, conventional fishing lure enclosures are not easily manually actuated with one hand.

What is needed then is an improved enclosure apparatus for protectively covering a fishing lure.

### BRIEF SUMMARY OF THE INVENTION

One aspect of the present invention provides an enclosure apparatus for covering a fishing lure on a fishing rod. The apparatus includes a first panel defining a first concave region and a second panel pivotally attached to the first panel defining a second concave region generally facing the first concave region. A spring is positioned between the first and second panels. The spring includes a first spring end attached to the first panel and a second spring end attached to the second panel. The spring is operative for biasing the first and second panels in a closed position.

Yet another aspect of the present invention provides an enclosure including first and second panels pivotally attached. The enclosure defines an interior cavity and includes a first flange protruding outwardly from the first panel. A second flange protrudes outwardly from the second panel. A spring is disposed between the first and second panels. The spring is operative for biasing the first and second panels in a closed position.

A further aspect of the present invention provides a buoyant fishing lure enclosure apparatus for covering a fishing lure. The apparatus includes a hinged enclosure having a first side and a second side pivotally attached at a pivoting joint. The enclosure defines an interior cavity. A first flange protrudes from the first side. A second flange protrudes from the second side. A torsion spring is attached to the enclosure adjacent the pivoting joint. A first lever arm extends from the torsion spring into the first flange, and a second lever arm extends from the torsion spring into the second flange.

Numerous other objects, features and advantages of the present invention will be readily apparent to those skilled in the art upon a reading of the following disclosure when taken in conjunction with the accompanying drawings.

### BRIEF DESCRIPTION OF THE DRAWINGS

FIG. 1 illustrates a partially broken-away perspective view of one embodiment of a fishing lure enclosure attached to a fishing rod in a closed position in accordance with the present disclosure.

FIG. 2 illustrates a perspective view of one embodiment of a fishing lure enclosure in an open position in accordance with the present invention.

FIG. 3 illustrates partial cross-sectional view of Section 3-3 from FIG. 1 showing one embodiment of a fishing lure enclosure in accordance with the present invention.

FIG. 4 illustrates a partial cross-sectional view of one embodiment of a fishing lure enclosure in accordance with the present invention.

FIG. 5 illustrates a partial cross-sectional view of one embodiment of a fishing lure enclosure in accordance with the present invention.

### DETAILED DESCRIPTION

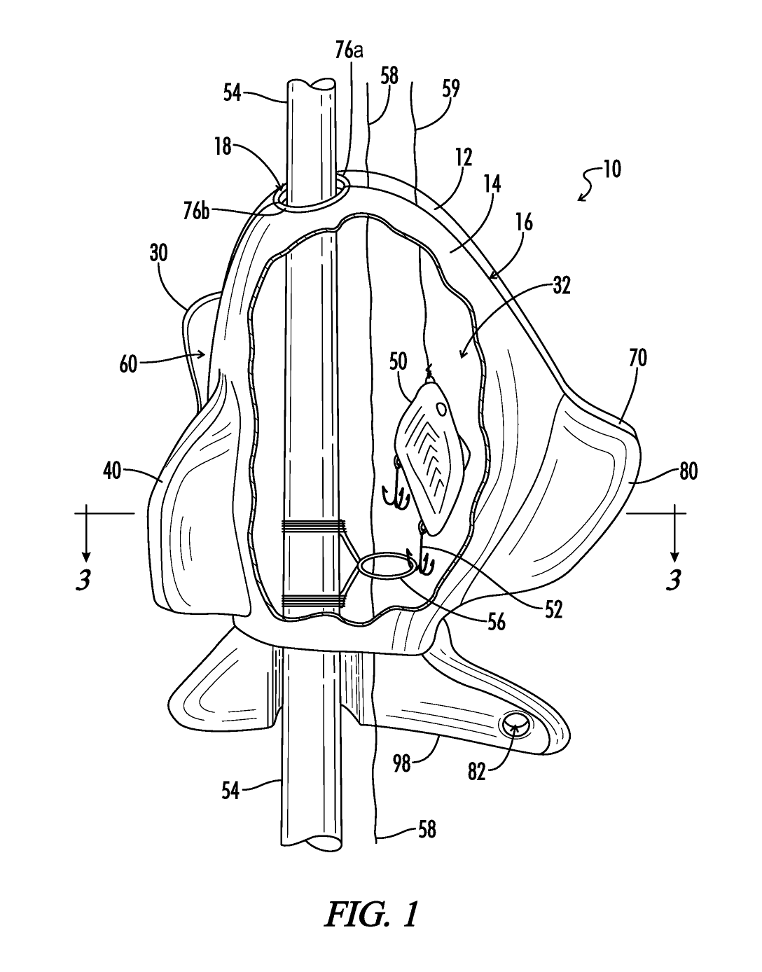

Referring now to the drawings, FIG. 1 illustrates a perspective view of one embodiment of an enclosure apparatus generally designated by the numeral 10. In the drawings, not all reference numbers are included in each drawing for the sake of clarity. In addition, positional terms such as “upper,” “lower,” “side,” “top,” “bottom,” etc. refer to the apparatus when in the orientation shown in the drawing. The skilled artisan will recognize that the apparatus can assume different orientations when in use.

Referring further to FIG. 1, one embodiment of an enclosure apparatus 10 includes a first panel 12 pivotally attached to a second panel 14. The first and/or second panels 12, 14 generally include a material that exhibits buoyancy in water, i.e. a material having a density less than about one-thousand kilograms per cubic meter. The first and second panels 12, 14 together define an interior cavity 32. The interior cavity 32 generally defines an enclosed volume that can be used to store one or more items. In one application, the enclosure apparatus 10 is used to enclose a fishing lure 50 when stowed on a fishing rod 54. For example, a user of a fishing rod 54 may temporarily secure one or more hooks 52 of a fishing lure 50 onto a structure extending from a fishing rod 54 such as a rod eyelet 56. The rod eyelet 56 generally provides a path for a first region of fishing line 58 supported by rod 54. A second region of fishing line 59 generally extends from the distal end of rod 54 and is attached to the fishing lure 50. When the lure 50 is attached to the rod eyelet 56 as seen in FIG. 1, the second region of fishing line 59 is doubled back from the distal end of the rod 54. By pulling the first and second regions of the fishing line taut when hook 52 is secured to rod eyelet 56, a user can temporarily secure the lure to the rod 54. Such temporary securement is generally useful during transportation or storage of the fishing rod and fishing lure.

Enclosure 10 can be affixed to the rod 54 to cover the fishing lure 50. As seen in FIG. 1, first and second panels 12, 14 meet at a panel seam 16. Also, a first flange 30 protrudes from first panel 12, and a second flange 40 protrudes from second panel 14. First and second flanges 30, 40 can be integrally formed on first and second panels, 12, 14, respectively, in some embodiments. In one embodiment first panel 12 and first flange 30 are integrally molded; and second panel 14 and second flange 40 are also integrally molded. In an additional embodiment, first and second panels 12, 14 and first and second flanges 30, 40 are all integrally molded as one continuous piece.

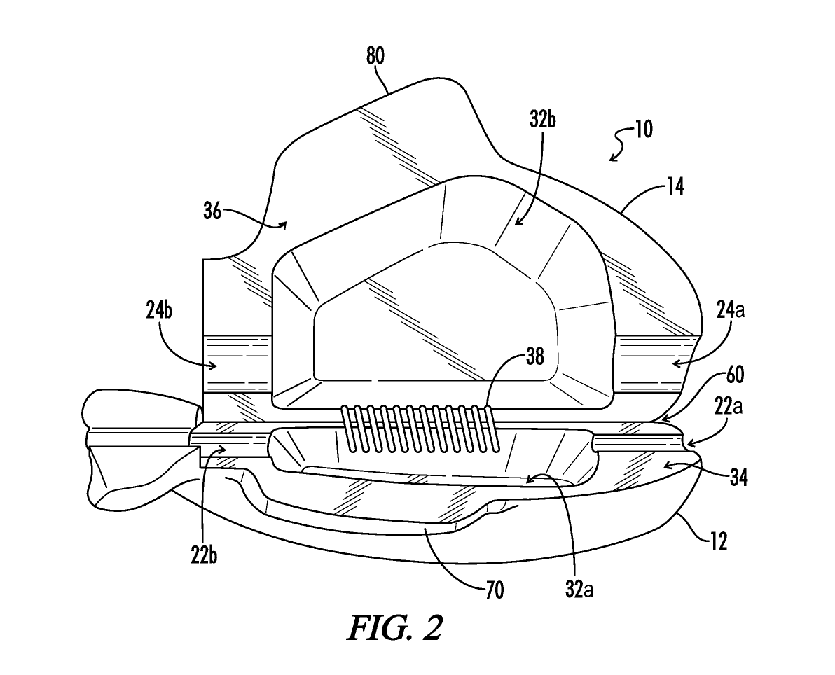

Referring further to FIG. 1, first and second panels are joined at a pivoting joint 60 such that enclosure 10 can be opened along panel seam 16, as illustrated in one embodiment in FIG. 2. As seen in FIG. 2, first panel 12 generally defines a first concave region 32a, and second panel 14 generally defines a second concave region 32b. First and second concave regions 32a, 32b generally face each other when enclosure 10 is in the closed position illustrated in FIG. 1. First and second concave regions 32a, 32b together define interior cavity 32. Also seen in FIG. 2, first panel 12 generally includes a first panel surface 34, and second panel 14 generally includes a second panel surface 36. First and second panel surfaces 34, 36 generally engage each other when enclosure 10 is in the closed position, as illustrated in FIG. 1. First and second panel surfaces 34, 36 in some embodiments are both substantially flat. In other embodiments, first and second panel surfaces 34, 36 can be textured and can include one or more retaining structures, such as magnets, hook-and-loop fabric, snap connectors, etc for releasably securing first and second panels in a closed position.

Also seen in FIG. 2, in some embodiments a spring 38 is disposed between first and second panels 12, 14 along pivoting joint 60. Spring 38 in some embodiments is a torsion spring. The spring 38 is operative in some embodiments for biasing the first and second panels 12, 14 in the closed position. Spring 38 can be made of a resilient material such as a metal or a plastic. In some embodiments, spring 38 is made of spring steel. Spring 38 can regularly be exposed to moisture during use and thus may include a non-corrosive or corrosion-resistant material. In one embodiment, the spring 38 includes stainless steel or an alloy thereof. In some embodiments, spring 38 is embedded entirely in enclosure 38 and is not exposed.

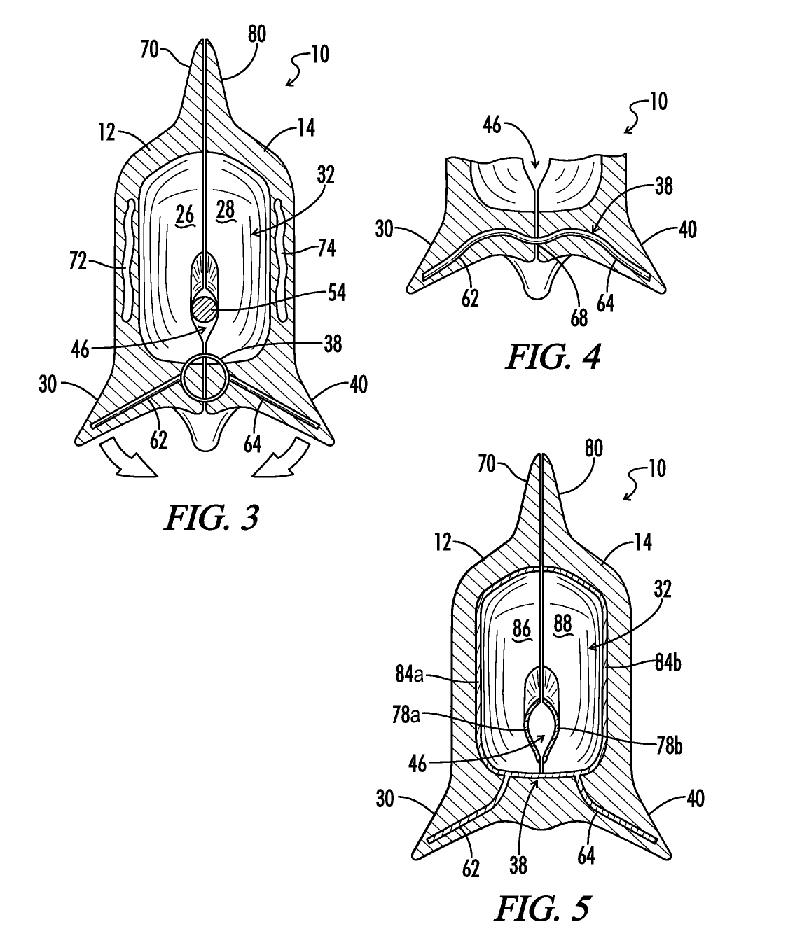

Referring now to FIG. 3, a cross-sectional view of Section 3-3 from FIG. 1 is illustrated in one embodiment. Spring 38 in this embodiment includes a helical coil spring having a first spring end 62 attached to the first panel 12 and a second spring end 64 attached to the second panel 14. The first spring end 62 in some embodiments includes an extended first free end of the coil which forms spring 38, and the second spring end 64 includes an extended second free end of the coil which forms spring 38. In this embodiment, first and second spring ends 62, 64 are integrally formed on spring 38.

As seen in FIG. 3, in some embodiments, first spring end 62 extends from spring 38 into first flange 30, and second spring end 64 extends into second flange 40. As such, a user can squeeze first and second flanges 30, 40 toward each other as indicated by the arrows in FIG. 3 to actuate spring 38, thereby opening enclosure 10 to an open position, as illustrated generally in FIG. 2. From the open position, the enclosure 10 can be removed from or installed onto a fishing rod 54.

Referring again to FIG. 1, when enclosure 10 is positioned on a fishing rod 54, first line region 58 and second line region 59 are both positioned between first and second panel surfaces 34, 36. In some embodiments, first and second panel surfaces 34, 36 exert a clamping pressure on first and second line regions 58, 59. First and second panel surfaces 34, 36 are generally adapted to prevent damage to first and second line regions 58, 59 and can include a rubber or plastic material in the regions of line contact.

Referring again to FIG. 2 and FIG. 3, when enclosure 10 is installed on a rod 54, rod 54 generally passes through one or more rod apertures defined in enclosure 10. A first, or front, rod aperture 18, illustrated in FIG. 1 provides a first passage for rod 54. First rod aperture 18 in some embodiments can include an inner diameter less than the diameter of a conventional fishing rod such that first rod aperture clamps against rod 54 with an interference fit, thereby longitudinally securing enclosure 10 relative to rod 54. In other embodiments, first rod aperture 18 includes an inner diameter equal to or greater than rod 54 outer diameter. First rod aperture 18 generally includes a first panel front groove 22a, defined on first panel 12, and a second panel front groove 24a, defined on second panel 14, as seen in FIG. 2. When first and second panels 12, 14 are in the closed position, first panel front groove 22a and second panel front groove 24a together define first rod aperture 18.

As seen in FIG. 3, a second, or rear, rod aperture 46 is defined at the opposite end of the enclosure 10. Rear rod aperture 48 generally provides a second passage for rod 54 when enclosure 10 is installed on the rod 54. Rear rod aperture 46 in some embodiments provides an inner diameter less than the rod outer diameter such that enclosure 10 engages rod 54 in an interference fit, thereby longitudinally securing enclosure 10 on rod 54. As discussed above regarding an interference fit between first rod aperture 18 and also as concerning the interference fit between second rod aperture 46 and rod 54, first and/or second panels 12, 14 can include a compressible material such as a foam to better facilitate an interference fit. The use of a compressible material in first and/or second panels 12, 14 also allows various fishing rods 54 having different diameters to be used with one enclosure 10.

As seen in FIG. 2, rear rod aperture 46 can include a first panel rear groove 22b defined in first panel 12, and second panel 14 can include a second panel rear groove 24b. The first panel rear groove 22b and second panel rear groove 24b can align to collectively form rear rod aperture 46.

Referring again to FIG. 1, in some embodiments, first rod aperture 18 includes a front aperture liner, or front aperture seal 76, surrounding first rod aperture 18. Front aperture liner 76 in some embodiments includes a material different than the material of the first and second panels 12, 14. In one embodiment, front aperture liner 76 includes a natural or synthetic rubber material for providing enhanced friction between enclosure 10 and rod 54. Such enhanced friction can improve the longitudinal securement of enclosure 10 on rod 54, especially when wet. In some embodiments, front aperture liner 76 includes a first front aperture liner section 76a attached to first panel 12 and a second front aperture liner section 76b attached to second panel 14.

Similarly, as seen in FIG. 5, second rod aperture 46 in some embodiments includes a rear aperture liner, or rear aperture seal, surrounding second rod aperture 46. Rear aperture liner in some embodiments includes a first rear aperture liner section 78a attached to first panel 12 and a second rear aperture liner section 78b attached to second panel 14. Rear aperture liner and first and second panels 12, 14 can include dissimilar materials. In some embodiments, rear aperture liner includes a natural or synthetic rubber material and can include a foam material. Additionally, first and second aperture liners 76, 78 can include a knurled or textured surface finish generally facing each respective rod aperture 18, 46 for further improving friction with rod 54.

As previously discussed, in some embodiments, enclosure 10 is buoyant so that enclosure 10 will generally float when placed in water. Enclosure 10 in some embodiments can provide a sufficient buoyancy force to support a rod and attached reel in water so that the rod and reel with attached enclosure 10 will at least partially float and can be retrieved if accidentally dropped in water. Referring further to FIG. 3, in some embodiments, the enclosure 10 includes a first panel 12 having a first internal gas pocket 72 encapsulated therein. A second internal gas pocket 74 can be encapsulated in second panel 14. First and second internal gas pockets 72, 74 can be filled with atmospheric air or any other gaseous composition including helium, nitrogen, oxygen, carbon dioxide, etc. or mixtures thereof. It will be appreciated that first and second internal gas pockets 72, 74 can include numerous individual pockets formed in a closed-cell foam material or other gas-filled matrix material forming first and second panels 12, 14.

In some embodiments, first and second panels include a closed cell foam including an air-filled or gas-filled matrix. The foam material comprising first and second panels 12, 14 can include a rubber or urethane foam, extruded polystyrene foam, or other conventional solid buoyant foams known in the art. Additionally, first and/or second panels 12, 14 can include compressed polystyrene. In some embodiments, the total combined volume of the enclosed gas pockets in the first and second panels 12, 14, including the enclosed gas in a closed-cell foam, is between about fifty cubic centimeters and about five-hundred cubic centimeters. In yet other embodiments, a total combined volume of enclosed air in the first and second panels 12, 14 is equal to or greater than about one hundred cubic centimeters.

Referring again to FIG. 3, in some embodiments, enclosure 10 includes a first inner panel surface 26 defined on first panel 12 and a second inner panel surface 28 defined on second panel 14. First and second panel surfaces 26, 28 generally face interior cavity 32. In some embodiments, first and second panels 12, 14 can include a relatively soft material that may be susceptible to being pierced by one or more fish hooks when a fishing lure is housed within enclosure 10, as seen in FIG. 1. To prevent one or more hooks from piercing and damaging first and second panels 12, 14 in some embodiments, a liner 84 can be positioned on first and/or second inner panel surfaces 26, 28. Liner 84 generally includes a first liner 84a disposed on first inner panel surface 26, and a second liner 84b disposed on second inner panel surface 28. First liner 84a includes a first liner surface 86, and second liner 84b includes a second liner surface 88. First and second liners 84a, 84b in some embodiments include a material that is dissimilar to the material of first and second panels 12, 14. In some embodiments, the material composition of first and second liners 84a, 84b includes a material with a greater density that the density of the material comprising first and second liners 12, 14. For example, in one embodiment first and second liners 12, 14 include a first material having a first density, and first and second liners 84a, 84b include a second material having a second density, wherein the first density is less than the second density. In some embodiments, the first material is a foam, such as a closed cell foam, and the second material is a thermoplastic or a thermosetting polymer, a plastic material or nylon material. As such, first and second panels 12, 14 can provide buoyant floatation to enclosure 10 while liner 84 protects the fishing lure 50 from puncturing first and second panels 12, 14. Liner 84 can include a liner thickness between about 0.5 millimeters and about 5.0 millimeters. In some embodiments, the liner 84 is attached to first and second panels 12, 14 using an adhesive. In another embodiment, liner 84 is attached to first and second panels using a conventional overmolding or injection molding process. In addition, liner 84 can provide a rigid surrounding for the lure for preventing the lure from being crushed by external forces applied to the outside of enclosure 10.

Referring now to FIG. 4, in some embodiments, spring 38 includes a bar spring, or torsion bar, having a first spring flange, or first lever arm 62, and a second spring flange, or second lever arm 64. Spring 38 in this embodiment includes a spring vertex 68 about which first and second lever arms 62, 64 can be resiliently deflected for opening and closing enclosure 10.

Referring again to FIG. 1, in some embodiments, enclosure 10 generally includes an ornamental design including the shape of a fish. The design includes a fish body, one or more pelvic fins, one or more dorsal fins and a tail fin. As seen in FIG. 1, in some embodiments, an attachment hole 82 is defined in enclosure 10. Attachment hole 82 can be defined in the tail fin 98 in some embodiments. The attachment hole 82 can be used for securing the enclosure 10 to an object such as a fishing vest, pack or other item.

Referring further to FIG. 1 and FIG. 2, in some embodiments enclosure 10 includes a third flange 70 extending from first panel 12 and a fourth flange 80 extending from second panel 14. Third and fourth flanges 70, 80 generally oppose each other. Third and fourth flanges 70, 80 in some embodiments can be used to manually close enclosure 10 from the open position seen in FIG. 2 to the closed position seen in FIG. 1.

In some embodiments, spring 38 is operative to bias first and second panels 12, 14 in a closed position as seen in FIG. 1. As discussed earlier, first and second panels can be opened along seam 16 by manually pressing first and second flanges 30, 40 toward each other. As first and second panels angularly rotate about pivoting joint 60, in some embodiments, spring 38 can additionally bias first and second panels into an open position, as seen in FIG. 2 after first and second panels pass through a predetermined angular spacing. For example, spring 38 can bias first and second panels 12, 14 in a closed position when first and second flanges are positioned in a first angular range. However, when first and second flanges are manually pivoted into a second angular range, first spring 38 can then bias first and second panels to the open position. As such, spring 38 can maintain first and second panels in an open position as illustrated in FIG. 2. A user can then manually install enclosure 10 onto a fishing rod 54 in the open position with one hand and can subsequently apply a compressive force against enclosure 10 to push first and second panels toward each other. Upon reaching the first angular range as first and second panels are pushed toward each other, spring 38 is once again operative for biasing first and second panels in the closed position.

As seen in FIG. 5, in some embodiments first and second panels 12, 14 can be continuously connected along pivoting joint 60, and first and second lever arms 62, 64 can be connected to first and second liners 84a, 84b, respectively. In some embodiments, first and second liners 84a, 84b are also connected along pivoting joint, and the connection between first and second liners 84a, 84b forms the torsion spring 38, as seen in FIG. 5.

The term “fishing lure” as used herein generally refers to a device having at least one hook generally adapted for attachment to a fishing line. The fishing lure can include an artificial lure shaped to imitate a baitfish, an insect, a reptile or any other living or nonliving matter that may be used to catch a fish. For example, in some embodiments, a fishing lure can include a plastic-bodied baitfish imitation such as a shad or crayfish and can include one or more hooks extending therefrom. In other embodiments, a fishing lure in accordance with the present disclosure can include one or more bare hooks generally adapted for receiving a bait or attractant material intended for catching fish. The hook can be barbed or barbless and can include various types of bait attached thereto. In some embodiments, a fishing lure can include a hook with natural or synthetic material wound about the hook, for example thread or other materials as commonly used on conventional fly-fishing lures.

The term “buoyant’ as used herein generally refers to the property of an item to fully or partially float when placed in water. Buoyancy can be imparted on an item by a material property wherein the material has a bulk density equal to or less than the density of water. Additionally, buoyancy can be imparted on an item by enclosing a fixed volume with a density less than or equal to the density of water.

The term “enclosure” as used herein generally refers to a structure having a concave region adapted for at least partially surrounding an item. An enclosure can have more than one concave region and can include multiple parts which collectively at least partially surround the item.

The term “fishing rod” as used herein generally refers to a device for supporting a line to which a fishing lure is attached. A fishing rod in accordance with the present invention can include an elongated pole of the type found on handheld fishing rods generally used in recreational fishing. In other embodiments, a fishing rod can include a fixed or cantilevered rod or boom attached to a structure such as a boat or a dock of the type use in commercial fishing applications.

The term “torsion spring” as used herein generally refers to an item that is biased toward a preferred angular orientation. In some embodiments, a torsion spring includes a helically-coiled material that, when twisted, exerts an angular force, or torque, on the items to which the spring is attached. In other embodiments, a torsion spring, or torsion bar, can include an item with first and second ends that when angularly deflected about an intermediate point, or vertex, between the first and second ends, exerts an angular force, or torque about the intermediate point, thereby biasing the first and second ends toward the original undeflected position.

Thus, although there have been described particular embodiments of the present invention of a new and useful Buoyant Fishing Lure Enclosure, it is not intended that such references be construed as limitations upon the scope of this invention except as set forth in the following claims.

What is claimed is:

1. An enclosure apparatus for covering a fishing lure on a fishing rod, the apparatus comprising:
a first panel defining a first concave region;
a second panel pivotally attached to the first panel defining a second concave region generally facing the first concave region; and
a spring having a first spring end attached to the first panel and a second spring end attached to the second panel,
wherein the spring is operative for biasing the first and second panels in a closed position.

2. The apparatus of claim 1, further comprising:
a first flange protruding from the first panel; and
a second flange protruding from the second panel,
wherein the first and second flanges are operative for being squeezed together by a user for pivoting the first and second panels away from each other.

3. The apparatus of claim 2, wherein:
the first flange protrudes downward from the first panel at a first angle between about thirty and about sixty degrees; and
the second flange protrudes downward from the second panel at a second angle between about thirty and about sixty degrees.

4. The apparatus of claim 2, wherein:
the first flange is integrally molded on the first panel; and
the second flange is integrally molded on the second panel.

5. The apparatus of claim 1, wherein the first and second panels comprise a closed-cell foam material.

6. The apparatus of claim 1, further comprising at least one first enclosed air pocket defined in the first panel.

7. The apparatus of claim 6, further comprising at least one second enclosed air pocket defined in the second panel.

8. The apparatus of claim 7, wherein the total combined volume of the enclosed air pockets in the first and second panels is between about fifty cubic centimeters and about five-hundred cubic centimeters.

9. The apparatus of claim 8, wherein the total combined volume of the enclosed air pockets in the first and second panels is greater than about one-hundred cubic centimeters.

10. The apparatus of claim 1, further comprising:
the first and second panels defining an interior enclosure surface; and
a liner disposed on the interior enclosure surface.

11. The apparatus of claim 10, wherein:
the first and second panels comprise a first material; and
the liner comprises a second material, the second material being dissimilar to the first material.

12. The apparatus of claim 11, wherein the liner comprises a thermoplastic polymer.

13. The apparatus of claim 10, wherein the liner comprises a rubber.

14. The apparatus of claim 10, wherein the liner includes a liner thickness between about 0.5 millimeters and about 5.0 millimeters.

15. The apparatus of claim 10, wherein the liner is attached to the interior enclosure surface by an adhesive.

16. An enclosure apparatus for covering a fishing lure, the apparatus comprising:
an buoyant enclosure including first and second panels pivotally attached, the enclosure defining an interior cavity;
a first flange protruding outwardly from the first panel;
a second flange protruding outwardly from the second panel; and
a spring disposed between the first and second panels;
wherein the spring is operative for biasing the first and second panels in a closed position.

17. The apparatus of claim 16, further comprising:
a first lever arm protruding from the spring into the first flange; and
a second lever arm protruding from the spring into the second flange.

18. The apparatus of claim 16, further comprising:
the first and second panels comprising a first material having a first density; and
a liner disposed in the interior cavity attached to at least one of the first and second panels, the liner comprising a second material having a second density;
wherein the first density is less than the second density.

19. A buoyant fishing lure enclosure apparatus for covering a fishing lure, the apparatus comprising:
a hinged enclosure having a first side and a second side pivotally attached at a pivoting joint, the enclosure defining an interior cavity;
a first flange protruding from the first side;
a second flange protruding from the second side;
a torsion spring attached to the enclosure adjacent the pivoting joint;
a first spring end extending from the spring into the first flange; and
a second spring end extending from the spring into the second flange.

20. The apparatus of claim 19, wherein the enclosure comprises a closed cell foam material.

21. The apparatus of claim 20, wherein the volume of the gas entrapped in the closed cell foam material is greater than about fifty cubic centimeters.
